(19) United States
(12) Patent Application Publication
(10) Pub. No.: US 2015/0031798 A1
(43) Pub. Date: Jan. 29, 2015

(54) COMPOSITE MATERIALS FOR USE IN HIGH VOLTAGE DEVICES

(71) Applicant: ABB Technology AG, Affolternstrasse (CH)

(72) Inventors: Jens ROCKS, Freienbach (CH); Walter Odermatt, Jackson, TN (US)

(21) Appl. No.: 14/461,877

(22) Filed: Aug. 18, 2014

Related U.S. Application Data
(63) Continuation of application No. PCT/EP2013/052976, filed on Feb. 14, 2013.

(30) Foreign Application Priority Data
Feb. 20, 2012 (EP) 12156168.2

(51) Int. Cl. H01B 3/47; H01B 13/08

(52) U.S. Cl. CPC H01B 3/47; H01B 13/08
USPC 523/435; 525/106; 525/122; 525/55; 525/123; 525/227; 525/418; 525/454; 524/405; 524/436; 523/466; 523/445; 523/457; 523/468; 524/493; 524/494; 524/37; 29/605

(57) ABSTRACT

A composite material is disclosed for use in a high-voltage device having a high-voltage electrical conductor, the material containing a polymeric matrix and at least one fiber embedded in the polymeric matrix, the fibers having an average diameter of less than about 500 nm.

### RELATED APPLICATION(S)

This application claims priority as a continuation application under 35 U.S.C. §120 to PCT/EP2013/052976, which was filed as an International Application on Feb. 14, 2013, designating the U.S., and which claims priority to European Application No. EP 12156168.2 filed in Europe on Feb. 20, 2012. The entire contents of these applications are hereby incorporated by reference in their entireties.

### FIELD

The present disclosure relates to the field of high-voltage devices and discloses composite materials and their use in the manufacture of high voltage devices, for example, in high-voltage apparatuses like generators or transformers, or in high voltage installations like gas-insulated switchgears.

### BACKGROUND INFORMATION

The properties of insulating materials which can be used for the manufacture of the above mentioned devices, for example, bushings, can include good electrical insulation (high resistance), high dielectric strength, good mechanical properties (for example, tenacity and elasticity), and they should not be affected by surrounding chemicals. The materials should also be non-hygroscopic because the dielectric strength of any material can be negatively affected by moisture.

A high-voltage outdoor bushing is a component that can be used to carry current at high potential from an encapsulated active part of a high-voltage component, for example, a transformer or a circuit breaker, through a grounded barrier, for example, a transformer tank or a circuit breaker housing, to a high-voltage outdoor line. Such bushings can be used in high voltage devices, for example, in switchgear installations or in high-voltage machines, for example, generators or transformers, for voltages up to several hundred kV.

In order to decrease and control the resulting high electric field, bushings can include a conductor extended along an axis, a condenser core and an electrically insulating polymeric weather protection housing moulded on the condenser core. The condenser core can decrease the electric field gradient and can distribute the electric field homogeneously along the length of the bushing. Thereby, the condenser core can provide a relatively uniform electric field and can facilitate the electrical stress control.

The condenser core can contain an electrically insulating material, and depending on the type of material, there are several kinds of condenser cores. According to known condensers, the condenser core of a bushing can be wound from kraft paper or creped kraft paper as a spacer. The condenser cores can be impregnated either with oil (OIP, oil-impregnated paper) or with resin (RIP, resin-impregnated paper). RIP bushings have shown that they represent dry (oil free) bushings. The core of an RIP bushing can be wound from paper. The resin can then be introduced during a heating and vacuum process of the core. However, the process of impregnating the pre-wound stack of paper and metal films with oil or with a resin for impregnated paper bushings can be a slow process.

The next generation of resin-impregnated cores for bushings can be represented by devices in which the bushing has a conductor and a core surrounding the conductor, wherein the core includes a sheet-like spacer wound in spiral form around the conductor. The spacer can be impregnated with an electrically insulating matrix material. By the spiral winding of the spacer, a multitude of neighbouring layers can be formed. The core can include equalization elements with electrically conductive layers, which can be arranged in appropriate radial distances to the axis. The layers can have openings, through which openings the matrix material can penetrate. Such a device is disclosed in EP 1,798,740 A.

According to known condenser cores, a polyester fabric can replace the paper as a means to give mechanical strength to the condenser core and to support the conducting material which can be used for electrical field grading within the condenser core body. Because the fabric can exhibit an open weave or open knit structure, an improved impregnation, drying and processing can be achieved as compared with paper.

The fabric can act as a spacer, and therefore fibers of normal thickness or relatively thick fibers have been used, so that the desired volume of the core can be obtained without excessive winding and at a reasonable cost.

However, it has been observed that the fibers tend to delaminate from the matrix material in which they are embedded. Accordingly, internal cavities, or free spaces, can result between the fibers and the matrix material.

The formation of such cavities between the matrix and the fibers can lead to partial discharge and consequently to a potentially fatal failure of the insulation. For example, even singular flaws in the insulation volume and in homogeneities at inner material interfaces can compromise the isolation capability. Therefore, there is a desire to reliable reduce the risk of such delamination.

### SUMMARY

A composite material is disclosed for use in a high-voltage device having a high-voltage electrical conductor, the composite material being adapted for covering the high-voltage electrical conductor at least partially for grading an electrical field of the high-voltage electrical conductor, the composite material comprising: a polymeric matrix; and at least one fiber embedded in the polymeric matrix, the at least one fiber having an average diameter of less than about 500 nm.

A high voltage device is disclosed comprising: a high-voltage electrical conductor; and a composite material having a polymeric matrix, and at least one fiber embedded in the polymeric matrix, the at least one fiber having an average diameter of less than about 500 nm, and wherein the composite material covers the conductor at least partially for grading an electrical field of the high-voltage electrical conductor.

A method of manufacturing a high-voltage device is disclosed, the method comprising: providing a high-voltage electrical conductor; winding at least one fiber around the high-voltage electrical conductor, each fiber having an average diameter of less than about 500 nm; and embedding the fibers or the fabric in a polymeric matrix, thereby obtaining a composite material which includes the fibers embedded in the polymeric matrix.

### BRIEF DESCRIPTION OF THE DRAWINGS

The subject matter of the disclosure will be explained in more detail in the following text with reference to exemplary embodiments, which are illustrated in the attached drawing, in which:

FIG. 1 shows an exemplary embodiment of a high-voltage outdoor bushing according to the disclosure with an axial partial section through the bushing on the right.

### DETAILED DESCRIPTION

In accordance with an exemplary embodiment, an insulation material is disclosed, for example, an insulation material for use in the manufacture of high voltage bushings or other high-voltage devices. In accordance with an exemplary embodiment, the insulation material can show no or at least very small free spaces between the fiber and the cured matrix material. In addition, a method of manufacturing a high-voltage device is disclosed, which can include the above insulation material.

In accordance with an exemplary embodiment, a composite material is disclosed for use in a high-voltage device having a high-voltage electrical conductor, the composite material being adapted for covering the high-voltage electrical conductor at least partially for grading an electrical field of the high-voltage electrical conductor, the composite material including: a polymeric matrix; and at least one fiber embedded in the polymeric matrix, the at least one fiber having an average diameter, for example, of less than about 500 nm.

In accordance with an exemplary embodiment, the composite material can be used for the manufacture of a high voltage device.

In accordance with an exemplary embodiment, a high voltage device is disclosed, which can include a high-voltage electrical conductor, and the composite material disclosed herein. The composite material can cover the conductor at least partially for grading an electrical field of the high-voltage electrical conductor.

In accordance with an exemplary embodiment, a method of manufacturing a high-voltage device is disclosed, which can include: providing a high-voltage electrical conductor, winding at least one fiber around the high-voltage electrical conductor, the fibers having an average diameter of less than 500 nm, and embedding the fibers or the fabric in a polymeric matrix. Thereby, a composite material, which includes the fibers embedded in the polymeric matrix, can be obtained.

In accordance with exemplary embodiment, the diameter of the fibers can be from about 20 nm to 500 nm, for example, from about 50 nm to about 500 nm. In accordance with an exemplary embodiment, the average fiber diameter can be, for example, 80 nm or 100 nm, which can reduce cost. In accordance with an exemplary embodiment, the fiber diameter can be, for example, 400 nm or 300 nm, which can further reduce the risk of delamination.

As used herein “high voltage device” can be defined as a device adapted for carrying a voltage of, for example, at least 1 kV AC or 1.5 kV DC through a possibly grounded interface. For example, the voltage rating for a high voltage device can be between about 17.5 kV and about 800 kV. Rated currents can, for example, be between 1 kA and 50 kA.

As used herein “fiber” shall mean a single fiber as well as a plurality of fibers. The at least one fiber can form a woven or non-woven fabric. In accordance with an exemplary embodiment, the at least one fiber can form at least one sheet-like layer in the polymer matrix.

In accordance with an exemplary embodiment, the fiber used in the manufacture of the composite materials can be made from electrically insulating or electric conductive organic or inorganic materials.

Suitable materials of the fiber can include organic polymers such as polyolefins, for example, polyethylene (PE) or polypropylene, polyesters, polyamides, aramides, polybenzimidazoles (PBI), polybenzobisoxazoles (PBO), polyphenylene sulphides (PPS), melamine based polymers, polyphenols, polyimides.

In accordance with an exemplary embodiment, the fiber can be from inorganic materials (for example alumina or glass), for example, such as S-glass fiber, E-glass fiber, Altex fiber (Al₂O₃/SiO₂), Nextel fiber (Al₂O₃/SiO₂/B₂O₃), quartz, carbon (graphite fibers), basalt fibers (SiO₂/Al₂O₃/CaO/MgO), alumina fibers (Almax fiber, Al₂O₃) Boron fibers, Silicon carbide fiber (SiC, SiCN, SiBCN), Beryllium fibers, or fibers from ceramic materials and/or from electrically conductive materials, such as metal or graphite. In accordance with an exemplary embodiment, the fiber(s) can be made from non-conductive materials but coated with at least one electrically conductive or with at least one semi-conductive layer.

Fibers from organic material, for example, from polymers or copolymers, can be used since the physical properties of organic polymers can be tuned so that the polymers, and the fibers, which are made from these polymers, can optimally perform for their intended use. Properties that can be tuned can include, without limitation, for example, Tg (glass transition temperature), molecular weight (both Mₙ and M_{w}), polydispersity index (PDI, the quotient of M_{w}/Mₙ) and degree. For example, in accordance with an exemplary embodiment, the polymers can be designed to have low Tgs (glass transition temperature), which can be “sticky” and such low-Tg-polymers can have beneficial features in that these polymers can be more elastic at a given temperature than polymers having higher Tgs (glass transition temperature).

In accordance with an exemplary embodiment, fibers that have a low or vanishing water uptake can be used, for example, a water uptake that is small compared to the water uptake of cellulose fibers.

In accordance with an exemplary embodiment, the fibers can be provided as single fibers forming a woven layer (fabric) or a non-woven layer. In accordance with an exemplary embodiment, single monofilament fibers can reduce the risk of delamination more reliably than a bundle of fibers.

The matrix material can be a polymer-based material. These polymers can be represented by resins on the basis of a silicone, epoxy polymers, hydrophobic epoxy polymers, unsaturated polyesters, for example poly vinylesters, polyurethanes, poly phenols, polycarbonates, polyether imines (Ultem™), copolymers and/or mixtures thereof. In accordance with an exemplary embodiment, the polymers can be represented by hydrophobic epoxy polymers.

The at least one fiber can be coated with an adhesion promoting agent which can allow the physical or chemical of the at least one fiber attachment to the polymer matrix. Suitable adhesion promoting agents can be represented by adhesion promoting organic polymers such as polyvinyl alcohols, polyvinyl acetates (PVA), carboxymethyl cellulose, polyacrylic (PAA) or polymethacrylic acids (PMA), styrene/maleic acid anhydride copolymers poylurethanes, cyanacrylates as well as copolymers and mixtures thereof.

Such polymeric adhesion promoting agents, for example, polyurethanes, can provide for the attachment of a great number of fibers which can be made from different fiber materials to a variety of polymer matrices. Epoxy polymers can form a heat and chemical resistant attachment of the fibers to the matrix; moreover, epoxy polymers can form strong bonds and represent good electrical insulators. Polyvinyl acetates (PVA) can lead to a connection between the fiber(s) and the matrix having thermoplastic characteristics. Methacrylate polymers adhesion promoting agents can form connections between the fiber(s) and the matrix material, which can exhibit a good impact resistance, flexibility and shear strength. The selection of cyano acrylate polymers can result in short cure times, which can lead to a short manufacturing time of composite materials or of the high voltage devices.

The fibers can have a mechanically treated surface, for example a roughened surface, for improved adhesion of the matrix material. The mechanically treated surface can be brushed, etched, coated or otherwise treated, which can further reduce the risk of delamination.

In accordance with an exemplary embodiment, the disclosure described herein can be applicable with polymeric fibers, but can also be applicable with other organic or inorganic fiber materials. For example, the disclosure can be applicable with fibers which can due to their chemical characteristics do not form a covalent bond to the matrix material, for example, to the epoxy polymer, or which cannot be impregnated due to their physical structure.

In accordance with an exemplary embodiment, the matrix material can include filler particles. For example, the matrix can include a polymer containing filler particles. The polymer can, for example, be represented by an epoxy resin, a polyester resin, a polyurethane resin, or another electrically insulating polymer as outlined above. For example, the filler particles can be electrically insulating or semiconducting. Suitable filler particles can, for example, be represented by particles selected from inorganic compounds, such as SiO₂, Al₂O₃, BN, AlN, BeO, TiB₂, TiO₂, SiC, Si₃N₄, B₄C or the like, or mixtures thereof. In accordance with an exemplary embodiment, a mixture of various such particles in the polymer can be used. In accordance with an exemplary embodiment, for example, the physical state of the particles can be solid.

In accordance with an exemplary embodiment, compared to a core with un-filled resin as matrix material, there can be less resin in the core, if a matrix material with a filler is used. Accordingly, the time used to cure a curable monomer or oligomer mixture can be reduced, which can reduce the time, which is needed to manufacture a high voltage device.

In accordance with an exemplary embodiment, the coefficient of thermal expansion of the filler particles can be smaller than the coefficient of thermal expansion of the polymer. For example, if the filler material is chosen accordingly, the thermo-mechanical properties of the high voltage devices can be considerably enhanced. A lower coefficient of thermal expansion of the core due to the use of a matrix material together with a filler can lead to a reduced total chemical shrinkage during curing. This can enable the production of (near) end-shape devices, or for example, bushings (machining free) and, therefore, can reduce the production time of the high voltage device such as a bushing.

In accordance with an exemplary embodiment, the composite material can include electrically conductive or semiconductive sheet-like layers dispersed in the matrix as electrical field equalization layers.

In accordance with an exemplary embodiment, the fibers of the composite material disclosed herein can be replaced by fibers having an average diameter of more than 500 nm, if the fibers, for example, are coated with the above disclosed adhesion promoting agent. In accordance with an exemplary embodiment, the risk of delamination can be reduced by the adhesion promoting agent and not by the geometry of the fibers. However, a fiber with less than 500 nm in diameter can be preferred. If such a small-radius fiber is combined with the above disclosed adhesion promoting agent, the fiber geometry and the adhesion promoting agent can have a synergy effect for reducing the risk of delamination most efficiently.

In accordance with an exemplary embodiment, the high voltage device described herein can be one of the following: a transformer winding of a high-voltage transformer; a current transformer for high voltage application; a high-voltage through-conductor, wherein the composite material is a bushing surrounding the high-voltage through-conductor; a high-voltage cable end termination, wherein the composite material is a cable end insulator surrounding the cable end.

Each of the aspects and embodiments described herein can be combined with other aspects and embodiments, whereby additional aspects and embodiments can be obtained. It is intended that all these aspects and embodiments can be part of the disclosure herein.

In the following, the exemplary use of the composite materials of the present disclosure is explained using a bushing as example. However, it will be understood, that the composite materials can be used in a great variety of applications inside as well as outside of the field of high voltage engineering.

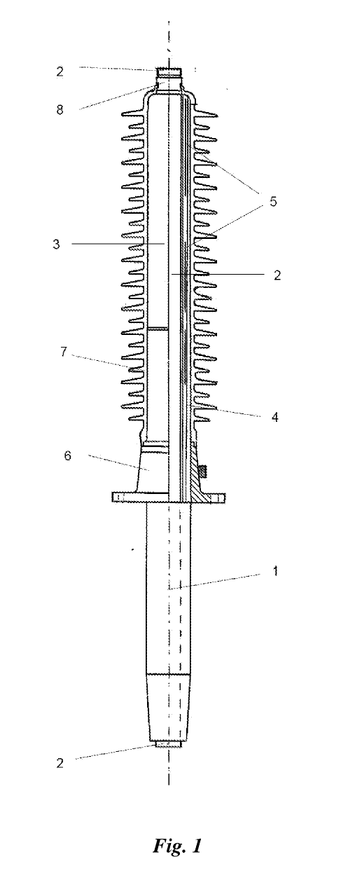

FIG. 1 shows an exemplary embodiment of the high-voltage outdoor bushing according to the disclosure with an axial partial section through the bushing on the right.

The bushing, which is shown in FIG. 1, can be substantially rotationally symmetric with respect to a symmetry axis 1. In the center of the bushing can be arranged a columnar supporting body 2, which can be executed as solid metallic rod or a metallic tube. The metallic rod (supporting body 2) can be an electric conductor, which connects an active part of an encapsulated device, for example a transformer or a switch, with an outdoor component, for example, a power line.

In an exemplary embodiment, the supporting body 2 can be a tube in which the electrical conductor, such as an end of a cable, is received. In this case, the conductor can be guided from below into the supporting body 2 (tube). The supporting body 2 can be a rod, a tube or a wire. For example, in the following, the supporting body 2 can be described as a conductor.

The axis 1 does not need to be a full symmetry axis. The axis 1 can be generally defined through the shape of the supporting body 2.

The supporting body 2 can be partially surrounded by a core 3, which is substantially rotationally symmetric with respect to the axis 1. The core 3 can cover the supporting body 2 between an upper axial end 8 and a lower axial end.

The core 3 can be made of the composite material according to an aspect of the present disclosure. The core 3 can include an insulating layer 4 of one or more fibers, which is/are wound around the conductor 2. The insulating layer 4 can be embedded in and impregnated with a matrix material.

The fiber 4 can be any fiber disclosed herein, having an average diameter of less than, for example, 500 nm. For example, in accordance with an exemplary embodiment, a polyester fiber can be used. The fiber 4 can form one or more woven or non-woven layers, or sheet-like spacers, which can be wound in spiral form around the axis 1. Thus a multitude of neighbouring layers can be formed.

The fiber 4 can be impregnated with an electrically insulating matrix material. The matrix can be any polymeric matrix disclosed herein. The matrix material, for example, can be a cured polymer-based resin and optionally filled with an inorganic filler powder. For example, the matrix can be an epoxy resin or polyurethane filled with particles of Al₂O₃. In an exemplary embodiment, the filler powder can include, for example, approximately 45% by volume of the matrix material before curing. In an exemplary embodiment, the matrix can include an epoxy resin, which can be cured with an anhydride and as filler powder fused silica. The sizes of the fused silica particles can be up to, for example, 64 μm and can include three fractions with different average particle sizes, such as, for example, sizes of 2, 12 and 40 μm respectively.

The thermal conductivity of the core in the case of pure (not particle-filled) resin can be, for example, about 0.15 W/mK to 0.25 W/mK. When a particle-filled resin is used, values of at least, for example, 0.6 W/mK to 0.9 W/mK or even above, for example, 1.2 W/mK or 1.3 W/mK for the thermal conductivity of the bushing core can be achieved. The coefficient of thermal expansion can be much smaller when a particle-filled matrix material is used. This results in less thermo-mechanical stress in the bushing core.

Electrically conductive grading insertions, or equalization elements, 5 can be arranged between adjacent windings of the tape 4. The grading insertions 5 can serve as floating capacitances, which can homogenize and control the electric field, thereby decreasing the electric field gradient. The conductive grading insertions 5 can be provided as layers, which can be separate from the fiber layers (the layer defined by the fiber 4). The grading insertions 5 can be formed as respective layers made from fibers coated with an electrically conductive coating. Alternatively or additionally, the grading insertions 5 can be formed as conductive films. The grading insertions 5 (for example conductive films) can be continuous or be provided as a plurality of separate parts (for example films), which can be not connected to each other but which can be positioned at a common diameter.

The conductive grading insertions 5 and the fiber 4 can form alternating layers, both being wound spiral-like around the conductor 2. In accordance with an exemplary embodiment, there can be, for example, between two and fifteen fiber layers between neighbouring grading insertion layers. In accordance with an exemplary embodiment, there can be, for example, only one, or more than fifteen, fiber layer(s) between neighbouring grading insertion layers.

At a radial end of the bushing, a foot flange 6 can be provided, which can allow the bushing to be fixed to a grounded enclosure of the encapsulated device. Under operation conditions the conductor 2 is on high potential, and the condenser core 3 can ensure the electrical insulation between the conductor 2 on the one hand and the outside including the flange 6 on the other hand.

Further, an electrically insulating weather protection housing 7 can surround the core 3 on the outside. The weather protection housing 7 can be manufactured from a polymer such as a silicone or a hydrophobic epoxy resin. The housing 7 can include sheds and can be moulded on the condenser core 3 such that it extends from the top of the foot flange 6 along the adjoining outer surface of the condenser core 3 to the upper end 8 of the conductor 2. The housing can protect the condenser core 3 from ageing caused by radiation (UV) and by weather and can maintain good electrical insulating properties during the entire life of the bushing. The shape of the sheds can be designed, such that it has a self-cleaning surface when it is exposed to rain. For example, this can avoid dust or pollution accumulation on the surface of the sheds, which could affect the insulating properties and lead to electrical flashover.

An adhesive layer can be deposited on the covered surfaces of the parts 2, 3 and 6, which can improve adhesion of the various components to each other and to the housing 7.

In accordance with an exemplary embodiment, an intermediate space can be between the core 3 and the housing 7, an insulating medium, for example an insulating liquid like silicone gel or polyurethane gel, can be provided to fill that intermediate space, or any other space within the bushing.

In accordance with an exemplary embodiment, the manufacturing of the bushing of FIG. 1 is disclosed. First, the supporting body (electrical conductor) 2 is provided and mounted on a winding spool or the like. Then, one or more fibers can be wound around the supporting body 2 by rotating the supporting body 2 on the winding spool. The fiber 4 can be any fiber disclosed herein, for example, having an average diameter of less than 500 nm. The fiber 4 can be provided as a woven or non-woven tape-like layer with a width direction extending along the axis 1. The layer can be provided as one or more strips or pieces, for example, axially adjacent to one another and/or on top of one another, so that several layers can be produced by winding the supporting body 2 about the axis once.

The grading insertions 5 can be wound between two layers of fiber 4. In accordance with an exemplary embodiment, the grading insertions 5 can be inserted into the core after certain numbers of windings, so that the grading insertions can be arranged in a well-defined, prescribable radial distance to the supporting body 2. Then, the winding process can be continued so that the grading insertion 5 in the fabricated bushing lies between two layers of fiber layer 4. In accordance with an exemplary embodiment, possibility the grading insertion 5 can be fixed to one or more stacked layer(s) of fiber before or during winding.

In accordance with an exemplary embodiment, instead of winding the fiber 4 on the supporting body 2, the fiber 4 can be wound on a mandrel, which is removed after finishing the production process. Later the supporting body 2 can be inserted into the hole in the core 3, which is left at the place at which the mandrel was positioned. For example, in that case, the supporting body 2 can be surrounded by some insulating material like an insulating liquid in order to avoid air gaps between the supporting body 2 and the core.

Next, the wound core of the fiber(s) 4 can be immersed in the polymeric matrix material. In accordance with an exemplary embodiment, this can be done by applying a vacuum and applying the matrix material to the evacuated fiber (for example, to the not-yet-finished core) until the fiber is fully impregnated. The impregnation under vacuum can take place at temperatures of, for example, between about 25° C. and 130° C.

Then, the polymeric matrix material can be cured or otherwise hardened, in the case of an epoxy at a temperature of, for example, between 60° C. and 150° C. In accordance with an exemplary embodiment, the matrix material can then be post-cured in order to reach the desired thermo-mechanical properties. Then the core can be cooled down, eventually machined, and the flange 6, the insulating envelope 7 and other parts can be applied. As a result, a composite material can be obtained which includes the fibers embedded in the polymeric matrix material.

The above description relates to a bushing having the composite material according to aspects of the disclosure. In accordance with an exemplary embodiment, instead of a bushing, the above description can be equally applicable to other high-voltage devices, some of which have been mentioned herein. These other high-voltage devices can be manufactured in an analogous manner as the bushing described above.

In accordance with an exemplary embodiment, the composite material disclosed herein, the risk of a delamination between the fiber and the matrix material can be reduced considerably.

In accordance with an exemplary embodiment, the delamination can be a consequence of the different thermal expansion coefficient of the fibers and polymeric matrix, and of the strong temperature variations during the fabrication of the condenser core, as described above. For example, the geometry of the enclosed fibers in the matrix material can be frozen at a high temperature (for example the hotspot temperature in the case of an epoxy resin, or more generally at the reaction temperature of the polymerization process at which the matrix can be cured or hardened). Thereafter, the condenser core cools down to room temperature. During this cooling, the fibers and the matrix material undergo a mutually different change in volume and consequently delaminate from each other.

In accordance with an exemplary embodiment, the risk of delamination can be reduced when the fibers have a diameter, for example, of less than 500 nm. For example, this can be an unusual diameter for a fiber, which can serve as a spacer. In accordance with an exemplary embodiment, this small diameter can reduce the length scale on which the different thermal expansion between fiber and matrix material can be relevant; and thereby can reduce the tensions between fiber and matrix material due to this thermal expansion. For example, the relatively weak bonding between the fibers and the matrix material can be sufficient for avoiding delamination.

In addition, the bonding can be improved by having the fiber coated with an adhesion promoting agent, such as a primer. For example, the adhesion promoting agent can cause a covalent binding between the fiber and the matrix. In this manner, the adhesion promoting agent can improve the physical or chemical attachment of the fiber to the polymer matrix.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A composite material for use in a high-voltage device having a high-voltage electrical conductor, the composite material being adapted for covering the high-voltage electrical conductor at least partially for grading an electrical field of the high-voltage electrical conductor, the composite material comprising:
a polymeric matrix; and
at least one fiber embedded in the polymeric matrix, the at least one fiber having an average diameter of less than about 500 nm.

2. The composite material according to claim 1, wherein the at least one fiber has a diameter from about 20 nm to about 500 nm.

3. The composite material according to claim 1, wherein the at least one fiber has a diameter from about 50 nm to about 500 nm.

4. The composite material according to claim 1, wherein the at least one fiber comprises:
a plurality of fibers, or
a woven or non-woven fabric of the at least one fiber.

5. The composite material according to claim 1, wherein the polymeric matrix comprises:
a resin that includes an organic or inorganic polymer.

6. The composite material according to claim 5, wherein the organic or inorganic polymer comprises:
a silicone, an epoxy polymer, a polyester, a polyurethane, a polyphenole, copolymers thereof, a hydrophobic epoxy polymer, an unsaturated polyester, a polyvinylester, a polyurethane or a polyphenol, polycarbonates, polyether imines (Ultem™), copolymers and/or mixtures thereof, and/or a hydrophobic epoxy polymer.

7. The composite material according to claim 1, wherein the at least one fiber is made from an electrically insulating organic or inorganic polymer comprising:
polyethylene (PE), polyester, polyamide, aramide, polybenzimidazole (PBI), polybenzobisoxazole (PBO),polyphenylene sulphide (PPS), melamine based polymers, polyphenols, polyimides, S-glass fiber, E-glass fiber, Altex fiber (Al₂O₃/SiO₂), Nextel fiber (Al₂O₃/SiO₂/B₂O₃), quartz, carbon (graphite fibers), basalt fiber (SiO₂/Al₂O₃/CaO/MgO), alumina (Almax fiber, (Al₂O₃) Boron fiber, Silicon carbide fiber (SiC, SiCN, SiBCN), and/or Beryllium fiber.

8. The composite material according to claim 1, wherein the at least one fiber comprises:
ceramic materials; or
electrically conductive materials.

9. The composite material according to claim 8, wherein the electrically conductive materials comprise:
metal fibers or electrically conductive fibers, graphite fibers, or fibers which are made from non-conductive materials and coated with at least one electrically conductive or semi-conductive layers.

10. The composite material according to claim 1, wherein the at least one fiber is coated with an adhesion promoting agent which allows the physical or chemical attachment to the polymeric matrix.

11. The composite material according to claim 10, wherein the adhesion promoting agent comprises:
an organic polymer.

12. The composite material according to claim 11, wherein the organic polymer is selected from the group consisting of:
polyurethanes, epoxy polymers, polyvinylalcohols, polyvinylacetates, carboxymethyl celluloses, polyacrylic acids, polymethacrylic acids, and/or styrene/maleic acid anhydride copolymers.

13. The composite material according to claim 1, comprising:
filler particles dispersed in the polymeric matrix.

14. The composite material according to claim 1, comprising:
at least one sheet-like layer in the polymeric matrix formed from the at least one fiber.

15. The composite material according to claim 1, comprising:
electrically conductive or semiconductive sheet-like layers dispersed in the polymeric matrix as electrical field equalization layers.

16. A high voltage device comprising:
a high-voltage electrical conductor; and
a composite material having a polymeric matrix, and at least one fiber embedded in the polymeric matrix, the at least one fiber having an average diameter of less than about 500 nm, and wherein the composite material covers the conductor at least partially for grading an electrical field of the high-voltage electrical conductor.

17. The high voltage device according to claim 16, wherein the high-voltage electrical conductor is one of the following:
a transformer winding of a high-voltage transformer;
a current transformer for high voltage application;
a high-voltage through-conductor, wherein the composite material is a bushing surrounding the high-voltage through-conductor; or
a high-voltage cable end termination, wherein the composite material is a cable end insulator surrounding the cable end.

18. A method of manufacturing a high-voltage device, the method comprising:
providing a high-voltage electrical conductor;
winding at least one fiber around the high-voltage electrical conductor, each fiber having an average diameter of less than about 500 nm; and
embedding the fibers or the fabric in a polymeric matrix, thereby obtaining a composite material which includes the fibers embedded in the polymeric matrix.

19. The method according to claim 18, comprising:
hardening the polymeric matrix.
